(19) United States
(12) Patent Application Publication
(10) Pub. No.: US 2010/0114486 A1
(43) Pub. Date: May 6, 2010

(54) COMPUTER SYSTEM AND CONTROL METHOD FOR RECEIVING SATELLITE POSITIONING SIGNAL AT POWER-OFF STATE

(75) Inventor: Chia-Chang Chiu, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/266,535

(22) Filed: Nov. 6, 2008

(51) Int. Cl. G01C 21/00

(52) U.S. Cl. 701/213

(57) ABSTRACT

A computer system is operative to receive a satellite positioning signal at a system power-off state. The computer system includes a power supply device, a satellite positioning chip, a communication interface, a control chip and an actuation element. The power supply device provides an operation voltage. The satellite positioning chip receives the satellite positioning signal through an antenna. The communication interface electrically connects with the satellite positioning chip and the control chip. The control chip receives the operation voltage, supplies source voltage to the satellite positioning chip, and retrieves and processes the satellite positioning signal through the communication interface. The actuation element electrically connects with the control chip. When the computer system is triggered by the actuation element under the system power-off state, the control chip supplies source voltage to the satellite positioning chip, so as to retrieve and process the satellite positioning signal.

### BACKGROUND OF THE INVENTION

1. Field of the Invention

The present invention relates to a computer system equipped with a satellite positioning chip, and more particularly, to a computer system and control method for receiving satellite positioning signals at a system power-off state.

2. Related Art

In actual implementation, a computer system (such as desktop personal computer or notebook computer) equipped with a GPS (Global Positioning System) device has to use a specific software to actuate and initialize the GPS device at a “system power-on state”, and then to process and analyze satellite positioning signals received by the GPS device.

Therefore, at a “system power-off state”, the computer system can not actuate and operate the GPS device through a specific application program.

### SUMMARY OF THE INVENTION

To solve the aforesaid problems of the prior art, the present invention provides a computer system and control method for receiving satellite positioning signals at a system power-off state. The computer system and method facilitate a function to perform a specific action at the system power-off state when an actuation element is triggered (such as a pressed hotkey) to retrieve and process the satellite positioning signal received by the GPS chip. The specific action may be to display a current location of the computer system, to display a current system time or to update the current system time of a real-time clock of the computer system. Therefore, the user will still be able to know the current location or the current system time even the computer system is at the system power-off state.

In an embodiment of the present invention, a computer system is capable of receiving a satellite positioning signal at a system power-off state. When the computer system is at the system power-off state, a GPS chip in the computer system will still continuously receive the satellite positioning signal. Therefore, the computer system will not need to initialize the GPS chip when the computer system is switched from the system power-off state to the system power-on state.

In another embodiment of the present invention, a computer system for receiving a satellite positioning signal at a system power-off state includes a power supply device, a satellite positioning chip, a communication interface, a control chip and an actuation element. The power supply device provides an operation voltage. The satellite positioning chip receives the satellite positioning signal through an antenna. The communication interface electrically connects with the satellite positioning chip. The control chip receives the operation voltage, supplies source voltage to the satellite positioning chip, and retrieves and processes the satellite positioning signal through the communication interface. The actuation element electrically connects with the control chip. When the computer system is triggered by the actuation element under the system power-off state, the control chip supplies source voltage to the satellite positioning chip, so as to retrieve and process the satellite positioning signal.

In an embodiment of the present invention, a control method for receiving a satellite positioning signal at a system power-off state of a computer system. The computer system includes a power supply device, a satellite positioning chip, a control chip and an actuation element. The control method of the present invention includes the following steps. First of all, determine whether the computer system is at the system power-off state. Next, whether the actuation element is triggered. When the computer system is at the system power-off state and the actuation element is triggered, the control chip will supply source voltage and actuate the satellite positioning chip to receive and process the satellite positioning signal received by the satellite positioning chip. And then use the processed satellite positioning signal to perform a specific action corresponding to the actuation element.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 is a schematic block diagram illustrating a computer system for receiving satellite positioning signals at a system power-off state according to an embodiment of the present invention; and

FIG. 2 is an explanatory flow chart illustrating a control method for receiving satellite positioning signals at a system power-off state according to another embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

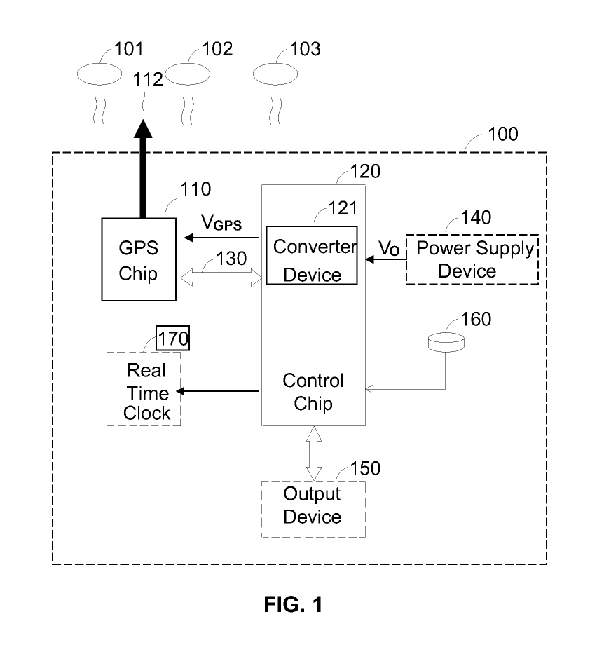

FIG. 1 is a schematic block diagram illustrating a computer system for receiving satellite positioning signals at a system power-off state according to an embodiment of the present invention. In the present embodiment, a computer system 100 mainly includes a GPS (Global Positioning System) chip (namely a “satellite positioning chip” in general) 110, a control chip 120, a communication interface 130, a power supply device 140, an output device 150, and an actuation element 160. Other system components of the computer system, such as central processing unit (CPU), system memory, bus bridge chip and system bus and etc., are omitted in FIG. 1. The power supply device 140 provides an operation voltage Vo. The satellite positioning chip 110 receives the satellite positioning signal through the antenna 112. The communication interface 130 electrically connects with the satellite positioning chip 110 and the control chip 120. The control chip 120 receives the operation voltage Vo from the power supply device 140, supplies source voltage V_{GPS} to the satellite positioning chip 110, and retrieves and processes the satellite positioning signal through the communication interface 130. The actuation element 160 electrically connects with the control chip 120. When the computer system 100 is at the system power-off state and the actuation element 160 is triggered, the control chip 120 supplies the source voltage V_{GPS} to the satellite positioning chip 110, so as to retrieve and process the satellite positioning signal.

In a possible practical implementation, the control chip 120 includes a keyboard controller (KBC) or an embedded controller (EC), which controls the power supply device 140 to supply electricity to some components of the computer system 100, such as a south bridge chip. In the present invention, at the system power-off state the control chip 120 is still supplied with the power supply device 140, namely a battery power (not shown) or with a DC (direct current) power (not shown) converted from an AC (alternating current) power source (not shown), so as to remain operative. The control chip 120 includes a pin electrically connected with the power supply device 140 to receive the operation voltage Vo at the system power-off state of the computer system 100. Therefore, the control chip 120 can still perform relevant functions such as supplying the source voltage V_{GPS} or retrieving the satellite positioning signal received by the GPS chip 110.

In the present embodiment, the control chip 120 further includes a converter device 121 to convert the operation voltage Vo into the source voltage V_{GPS}. The converter device 121 may be integrated in the control chip 120, or be independent from the control chip 120. Furthermore, the control chip 120 may uses the communication interface 130 to retrieve the satellite positioning signal from the GPS chip 110. The communication interface 130 may be a serial communication bus. Namely, to communicate with each other through the serial communication bus, the control chip 120 and the GPS chip 110 needs to be compatible with the serial communication bus, such each having a serial communication port to connect with the serial communication bus respectively.

When the computer system 100 is at the system power-off state, the control chip 120 controls (the converter device 121) to convert the operation voltage Vo supplied by the power supply device 140 into the source voltage V_{GPS}. When the control chip 120 supplies the source voltage V_{GPS} to the GPS chip 110, the GPS chip 110 is able to receive the satellite positioning signal. Then the control chip 120 will, through the communication interface 130, retrieve the satellite positioning signal received in the GPS chip 110.

When the control chip 120 retrieves the satellite positioning signal, the control chip 120 starts to process or parse the satellite positioning signal. According to the processed/parsed results of the satellite positioning signal, the control chip 120 performs a specific action. For example, the control chip 120 may, according to the processed/parsed satellite positioning signal, display on an output device 150 a current location of the computer system 100, or may update/rectify a current system of a real-time clock 170 of the computer system 100. The output device 150 may be a default display the computer system, or an auxiliary display independent from the default display of the computer system, such as a small 16x2 secondary liquid crystal display. The output device 150 may also be realized by any other output device that informs the user through video or audio outputs.

In a practical embodiment, the user may manually actuate the specific action. For example, when the computer system 100 is at the system power-off state, if the actuation element 160 is not triggered, it indicates that the user does not intend to actuate the specific action. Therefore, the GPS chip 110 is not actuated and will not receive the satellite positioning signals from satellites 101˜103.

The aforesaid actuation element 160 may be a common function key or hot/quick key. For example, the computer system may use one preset button or several preset combination buttons included in a keyboard of the computer system, or may add a designated button inside/outside the keyboard (with/without being included in the keyboard), or may use a remote button, as the actuation element. The actuation element 160 may be an actuation element that is able to generate any trigger event signals and is well-known to those skilled in the art.

When the computer system 100 is at the system power-off state, if the actuation element 160 is also triggered, the control chip 120 provides the source voltage V_{GPS}, to actuate the GPS chip 110. The GPS chip 110 receives the satellite positioning signal through the antenna 112; and then through the communication interface 130, the satellite positioning signal is sent/retrieved to the control chip 120. The control chip 120 processes the satellite positioning signal received by the GPS chip 110 and performs the specific action.

From the satellite positioning signal, there provides different string messages such as geographic latitude and longitude (String “$GPGLL”: Geographic position, latitude/longitude), direction of current location to a destination (String “$GPBOD”: Bearing, origin to destination), direction and distance toward a destination (String “$GPBWC”: bearing and distance to waypoint), date and time (String “$GPZDA”: date and Time), . . . and etc. The aforesaid “performing the specific action” in a practical embodiment, includes that the control chip 120 may access/analyze string data like latitude/longitude and the current time from the satellite positioning signal, and then send the results to the output device 150 to display thereon. The output device 150 may output the accessed/analyzed results by way of video or audio. Therefore, when the computer system 100 is at the system power-off state, by reading from the output device 150, the user may still be aware of certain GPS information for the computer system 100 such as the latitude/longitude data of the current location and the current satellite time.

In another practical embodiment regarding “performing the specific action”, the control chip 120 may access/analyze the current satellite time from the satellite positioning signal received by the GPS chip 110. Meanwhile, the current system time of the real-time clock (RTC) 170 in the computer system will be updated according to the accessed current satellite time.

In other practical embodiment, a first actuation element and a second actuation element (both not shown) or more may be configured to operate on the computer system 100. When the first actuation element is triggered, the control chip 120 may make the output device 150 output the messages (such as the aforesaid latitude/longitude data) within the satellite positioning signal. When the second actuation element is triggered, the control chip 120 may control to update the current system time of the real-time clock 170.

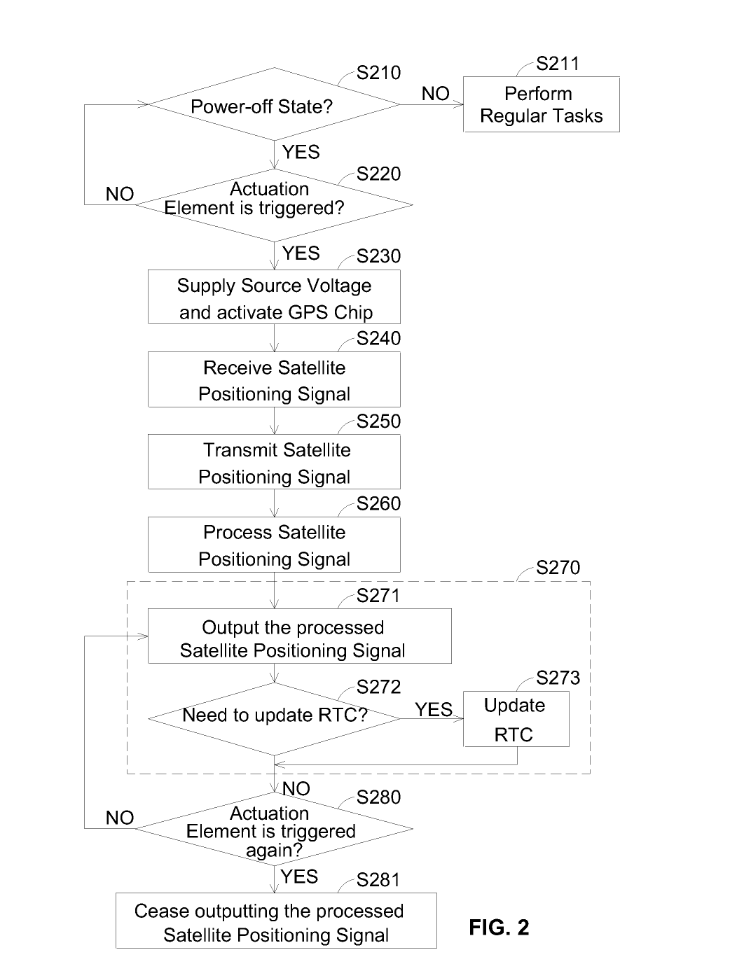

FIG. 2 is an explanatory flow chart illustrating a control method for receiving satellite positioning signals at a system power-off state according to another embodiment of the present invention. The computer system includes a power supply device, a satellite positioning chip, a control chip, a communication interface and an actuation element.

First of all, determine whether the computer system is at the system power-off state (Step S210). If the computer system is not at the system power-off state, perform regular tasks (Step S211). If the computer system is at the system power-off state, determine whether an actuation element is also triggered (Step S220). The actuation element may be a function key or a Hot Key/Quick Key, such as presetting a certain key or a set of certain keys involved in the keyboard of the computer system as the hot key/quick key, or providing an extra dedicated key on the keyboard or outside the keyboard, or a button on a remote controller. The actuation element may also be realized by any actuation element that generates trigger event signals and is well-known to those skilled in the art.

If the actuation element is not also triggered, return to Step S210. If the actuation element is also triggered, supply source voltage to the satellite positioning chip so as to activation the satellite positioning chip (Step S230). In the present embodiment, the control chip supplies source voltage to the satellite positioning chip. When the computer system is at the system power-off state, the control chip is still capable of supply voltage/electricity since the control device is still supplies with system power by the power supply device (battery only or DC power converted from AC power) at the power-off state. In a practical embodiment, the control chip may comprise a keyboard controller (KBC) of the computer system or an embedded controller (EC) implemented with KBC is features and functions.

The satellite positioning chip receives the satellite positioning signal for a satellite (Step S240). In a practical embodiment, the satellite positioning chip receives the satellite positioning signal through an antenna, such as a GPS antenna or embedded satellite antenna. Afterwards, transmit the satellite positioning signal to the control chip (Step S250). In the present embodiment, the satellite positioning chip transmits the received satellite positioning signal to the control chip through a communication interface like a serial communication bus; or alternatively, the control chip may access/retrieve the received satellite positioning signal from the satellite positioning chip through the serial communication bus.

Then, process the satellite positioning signal (Step S260). In the present embodiment, the control chip process (parse/analyze/access) the satellite positioning signal received by the satellite positioning chip. The satellite positioning signal may actually be processed (parsed/analyzed) so that the control chip can access or retrieve the processed satellite positioning signal to perform a specific action (Step S270). The satellite positioning signal provides different string messages such as geographic latitude and longitude (String “$GPGLL”: Geographic position, latitude/longitude), direction of current location to a destination (String “$GPBOD”: Bearing, origin to destination), direction and distance toward a destination (String “$GPBWC”: bearing and distance to waypoint), date and time (String “$GPZDA”: date and Time), . . . and etc.

In a practical embodiment, an output device outputs the processed results of the satellite positioning signal by way of video or audio. For example, a display device, especially an auxiliary display independent from a default display of the computer system, will be used to display the geography information of the current location of the computer system. In a practical embodiment, a satellite time obtained from the processed satellite positioning signal will be used to update the current system time of the real-time clock in the computer system.

In the present embodiment, Step S270 performs a specific action including displaying the processed satellite positioning signal (Step S271) and determining whether to update the current system time of the real-time clock (Step S272). As shown in FIG. 2, after Step S260 is performed, display the processed satellite positioning signal (Step S271). In the present embodiment, it is to use an output device (such as a default display of the computer system or an auxiliary display independent from the default display or an external display outside the computer system) to display the satellite positioning signal. In a practical embodiment, the control chip may control to supply necessary voltage to the output device since the power supply device of the computer system possibly does not supply system power to the output device at the power-off state.

Next, determine whether it is needed to update the current system time of the real-time clock RTC (Step S272). In a practical embodiment, the output/display device displays a user menu for the user. According to the selection results of the user menu, the current system time of the real-time clock RTC will be determined whether to update. When it is determined to update the current system time of the real-time clock RTC, a satellite time of the processed satellite positioning signal will be used to update the current system time of the real-time clock (Step S273). After updating the real-time clock RTC, determine whether the actuation element is also triggered again (Step S280).

In a practical embodiment, if the current system time of the real-time clock need not to be update, determine whether the actuation element is also triggered again (Step S280). If not, return to Step S270 and continue to perform the specific action. In the present embodiment, if the actuation element is not triggered again, the computer system continues to output/display the processed satellite positioning signal (Step S271). If the actuation element is triggered again, cease performing the specific action (Step S281). In the present embodiment, if the actuation element is triggered again, cease display/output the processed/ parsed/analyzed satellite positioning signal. In a practical embodiment, if the actuation element is triggered again, cease supplying source voltage to the satellite positioning chip.

Furthermore, the aforesaid embodiments of the present invention use US standard GPS as an example. However, for those skilled in the art, the present invention may also be adapted to other satellite positioning systems, such as the Galileo Positioning System of European standard.

Consequently, since the GPS chip (satellite positioning chip) is still capable of receiving the satellite positioning signal when the computer system is at the system power-off state, the GPS chip will not need to be reactivated again when the computer system is powered on from the system power-off state. Moreover, when the computer system is at the system power-off state, specific actions may be performed according to the satellite positioning signal received by the GPS chip (satellite positioning chip), such as displaying the current location or the current system time of the computer system.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A computer system, comprising:
a power supply device, providing an operation voltage;
a satellite positioning chip, receiving a satellite positioning signal through an antenna;
a communication interface, electrically connects with the satellite positioning chip;
a control chip, receiving the operation voltage, controlling to supply source voltage to the satellite positioning chip, and retrieving and processing the satellite positioning signal through the communication interface; and
an actuation element, electrically connecting with the control chip, wherein when the computer system is at a system power-off state and the actuation element is triggered, the control chip supplies source voltage to the satellite positioning chip so as to retrieve and process the satellite positioning signal.

2. The computer system as claimed in claim 1 further comprising an output device electrically connected with the control chip, when the actuation element is triggered at the system power-off state of the computer system, the output device outputs the processed satellite positioning signal.

3. The computer system as claimed in claim 2, wherein the output device is a display device, the display device being an auxiliary display independent from a default display of the computer system.

4. The computer system as claimed in claim 2, wherein the output device outputs longitude and latitude of a current location of the computer system, or outputs a current satellite time.

5. The computer system as claimed in claim 1, wherein the control chip includes a converter device to convert the operation voltage into the source voltage supplied for the satellite positioning chip.

6. The computer system as claimed in claim 1, wherein the communication interface is a serial communication bus.

7. The computer system as claimed in claim 1 further comprising a real-time clock electrically connected with the control chip, when the actuation element is triggered at the system power-off state of the computer system, a satellite time of the processed satellite positioning signal being used to rectify a current system time of the real-time clock.

8. The computer system as claimed in claim 1, wherein the control chip includes a keyboard controller.

9. The computer system as claimed in claim 1, wherein the actuation element is at least one button included in a keyboard of the computer system, or is a designated button without being included in the keyboard of the computer system.

10. A control method to receive a satellite positioning signal at a system power-off state of a computer system, the computer system comprising a power supply device, a satellite positioning chip, a communication interface, a control chip and an actuation element, the control method comprising the steps of:
determining whether the computer system is at the system power-off state of the computer system;
determining whether the actuation element is triggered;
when the computer system is at the system power-off state and the actuation element is triggered, the control chip supplying source voltage to and actuating the satellite positioning chip through the communication interface to retrieve and process the satellite positioning signal received by the satellite positioning chip; and
using the processed satellite positioning signal to perform a specific action corresponding to the triggered actuation element.

11. The control method as claimed in claim 10, wherein the specific action is to display on an output device current geography information of a current location of the computer system.

12. The control method as claimed in claim 11, wherein the output device is a display device, and the specific action is to update a current system time of a real-time clock of the computer system by using a current satellite time of the processed satellite positioning signal.

13. The control method as claimed in claim 12 further comprising the steps of:
displaying an user menu on the display device;
according to a selection result of the user menu, determining whether to update a current time of a real-time clock of the computer system;
when the current time of the real-time clock is determined to be updated, using a current satellite time of the processed satellite positioning signal to update the current time of the real-time clock.

14. The control method as claimed in claim 10, wherein the control chip comprises a keyboard controller of the computer system.

15. The control method as claimed in claim 10, wherein the actuation element is at least one button included in a keyboard of the computer system.

16. The control method as claimed in claim 10, wherein the actuation element is a designated button without being included in the keyboard of the computer system.

17. The control method as claimed in claim 10 further comprising the steps of:
determining whether the actuation element is triggered again; and
when the actuation element is triggered again, cease performing the specific action and cease supplying source voltage to the satellite positioning chip.

18. The control method as claimed in claim 10, wherein the communication interface is a serial communication bus.
